(19) United States
(12) Patent Application Publication
(10) Pub. No.: US 2026/0246247 A1
(43) Pub. Date: Aug. 20, 2026

(54) UNDERWATER VEHICLE AND METHOD FOR INSTALLING RETAINING DEVICES ON AN UNDERWATER PIPELINE

(71) Applicant: SAIPEM S.P.A., Milano (IT)

(72) Inventors: Francesco Lucchese, Milano (IT); Diego Lazzarin, Milano (IT)

(21) Appl. No.: 19/162,299

(22) PCT Filed: Mar. 7, 2024
(86) PCT No.: PCT/IB2024/052206

§ 371 Date: Sep. 4, 2025

(30) Foreign Application Priority Data
Mar. 9, 2023 (IT) 102023000004404

(51) Int. Cl. H02G 1/10; B25J 5/00; B63G 8/00; F16L 1/16; F16L 3/04; F16L 53/38

(52) U.S. Cl. CPC H02G 1/10; B25J 5/005; B63G 8/001; F16L 1/16; F16L 3/04; F16L 53/38; B63G 2008/005

(57) ABSTRACT

An underwater vehicle for installing retaining devices on a pipeline laid on a bed of a body of water has a frame; a first locomotion assembly and a second locomotion assembly, which are configured to advance the underwater vehicle on the bed of the body of water in a travel direction; a charging seat configured to accommodate a plurality of retaining devices; and an installation mechanism comprising a movable arm configured to take a retaining device from the plurality of retaining devices and to apply the retaining device taken on the underwater pipeline.

### PRIORITY CLAIM

This application is a national stage application of PCT/IB2024/052206, filed on Mar. 7, 2024, which claims the benefit of and priority to Italian Patent Application No. 102023000004404, filed on Mar. 9, 2023, the entire contents of which are each incorporated by reference herein.

### TECHNICAL FIELD

The present disclosure concerns an underwater vehicle and an installation method for installing retaining devices to retain a cable on an underwater pipeline laid on a bed of a body of water. Furthermore, the present disclosure concerns an application method for applying a cable to an underwater pipeline laid on a bed of a body of water.

### BACKGROUND

Generally, the operations of hydrocarbon extraction and production from a reservoir located in the bed of a body of water require that the fluid extracted from the underwater reservoir is conveyed along conveying systems that comprise pipelines laid on the bed of the body of water and along further pipelines called “risers”, which rise to the surface up to a surface infrastructure, such as for example a fixed platform or a floating system.

The fluid extracted from the reservoir is typically a mixture of hydrocarbons and organic compounds of carbon and hydrogen which often also contain sulphur, nitrogen, oxygen, water and other unwanted compounds. This mixture can be both in the liquid or gaseous state or can contain both phases.

To ensure the flow of the fluid in the pipelines, the fluid must be maintained within an adequate thermodynamic interval of pressure and temperature, outside of which some components of the fluid tend to precipitate forming solid deposits of hydrates and/or waxes that might obstruct the pipelines.

A technique to overcome certain of these drawbacks consists in the active heating of the conveying pipelines to ensure that the fluid remains at the desired temperature under all operating conditions. In particular, the term “active heating” indicates systems that supply energy to the fluid, thus differing from the passive systems which merely conserve energy inside the pipelines through thermal insulation.

A particular type of pipeline active heating is the Direct Electrical Heating, wherein an electric current flows through the pipelines, heating the metal of the pipelines by Joule effect.

One direct electric heating system comprises a cable commonly called “Direct Electrical Heating Piggy Back Cable (DEH-PBC)”, which represents a portion of the electrical circuit of the heating system and is secured astride the pipeline itself, in the so-called “piggyback” configuration, through retaining devices called “clamps”.

Typically, the cable is positioned at a relatively short distance from the transport pipeline with the aim of limiting the inductive effects linked to the electromagnetic interferences between cable and pipeline that generate an inductive power that is of no use for the purposes of heating the pipeline.

Furthermore, the cable is devoid of a metal protective armour. That is, the electromagnetic fields would generate eddy currents on the metal armour, and, consequently, would produce additional power that is of no use for the purposes of heating the pipeline. Therefore, the cable is provided with protections made of polymeric material, such as for example plastic segments, which increase the mechanical strength thereof.

One methodology for installing the cable in the piggyback configuration provides that the cable is installed by a pipe-laying ship simultaneously with the laying of the pipeline on the bed of the body of water. In greater detail, the installation of a cable in “piggyback” mode is related to a method for laying a metal pipeline, in which the pipe-laying ship lays a seamless pipeline on the bed of the body of water, which is called a “string” and is made starting from pieces of pipe called “joints” having conventional length of 12 metres. The joint is welded to the string along a launching line of the pipe-laying ship commonly referred to as the “firing line”. When a joint is added to the string, the pipe-laying ship advances by a length equal to the same welded section.

In particular, during laying on the bed of the body of water, the pipeline is subjected to relatively considerable forces and bendings that result in designing a retaining system between cable and pipeline that is particularly relatively rigid and typically consisting of bolted clamps or grips. This connection is made in a terminal workstation of the launching line of the pipe-laying ship.

However, the installation of the cable on the pipeline by retaining devices during the assembly and launching steps of the pipeline entails numerous drawbacks. In particular, the operations of installation of the cable on the pipeline slow down the assembly and the laying of the pipeline, consequently causing the associated operating costs to increase.

In addition, the space available to carry out the operations of installation of the cable on the pipeline aboard a laying ship is generally relatively limited. Sometimes it is impossible or unnecessarily risky to add processing stations on pipe-laying ships relatively highly optimized to the assembly and laying of only pipelines.

The installation itself of the cable on the pipeline according to certain known techniques involves risks of malfunction of the tightening clamps of the cable on the load-bearing pipeline, and, consequently, risks of stretching or breakage of the cable. In fact, the DEH-PBC cable, being without armour, is a cable relatively vulnerable to stretching, abrasion and crushing.

In addition, the installation of the cable on the pipeline before the launching step of the pipeline involves an increase in hydrodynamic resistance linked to the effects of the currents in the body of water on the increased profile of the assembly consisting of the cable and of the pipeline, reducing the operating limits of the pipe-laying ship.

A further drawback is linked to the possibility of a failure of the cable. In this case, it is necessary to carry out relatively particularly complex and expensive replacement operations, as it is impossible to replace the cable through ordinary maintenance operations.

### SUMMARY

Certain aims of the present disclosure are to realize an underwater vehicle for installing retaining devices in an underwater pipeline that mitigates certain of the drawbacks of certain of the prior art.

In certain embodiments, such aims of the present disclosure are to realize an underwater vehicle that enables a cable to be installed on a pipeline laid on the bed of a body of water without slowing down the productivity of the pipe-laying ship and relatively limiting the risks and the costs associated with the operations of installation of the cable on the pipeline.

Certain embodiments of the present disclosure are directed to an underwater vehicle for installing retaining devices to retain a cable on an underwater pipeline laid on a bed of a body of water. In these embodiments, the underwater vehicle comprises a frame; a first locomotion assembly and a second locomotion assembly, which are configured to advance the underwater vehicle on the bed of the body of water in a travel direction; a charging seat configured to accommodate a plurality of retaining devices, in certain instances stacked; and an installation mechanism comprising a movable arm configured to take a retaining device from the plurality of retaining devices and to apply the retaining device taken on the underwater pipeline.

In accordance with the present disclosure, it is possible to install the cable retaining devices on the pipeline directly on the bed of the body of water. In this way, it is possible to avoid the inconveniences associated with the installation of the retaining devices on the pipeline during the assembly and launching steps of the pipeline.

In certain embodiments, since the pipe-laying ship is dedicated only to laying the pipeline, it is possible to maintain the productivity of the pipe-laying ship unchanged and to lay the pipeline through the use of smaller-sized pipe-laying ships, relatively limiting the operating costs associated with the pipe-laying ship.

In addition, the retaining devices do not have to withstand the significant bending actions linked to the laying of the pipeline and consequently it is possible to realize relatively less rigid and heavy retaining devices, avoiding bolted connections that make any cable replacement operations relatively extremely complex.

In addition, in accordance with the present disclosure and as it pertains to the robotization of the installation, the relative risks for the personnel involved in installing the retaining devices on board the pipe-laying ship are relatively eliminated.

In certain embodiments, the movable arm of the installation mechanism comprises a gripping member for selectively grasping or releasing the retaining device. In greater detail, the gripping device comprises two movable gripping arms, each of which is provided with a sliding pin configured to engage a respective opening formed in the retaining device. In this way, it is possible to remove and install the retaining device on the pipeline in a relatively simple and quick way.

In certain embodiments, the installation mechanism comprises a slider, which is sliding with respect to the frame along a sliding direction transverse to the travel direction of the underwater vehicle. In certain such embodiments, the movable arm being hinged to the slider about a rotation axis to enable the rotation of the movable arm with respect to the slider between a taking position of the retaining device and an application position of the retaining device. In this way, it is possible to move the movable arm from the taking position to the application position and vice versa.

In certain embodiments, the charging seat of the underwater vehicle comprises a rotating support element configured to rotatably support the plurality of retaining devices to dispose the at least one retaining device proximate the movable arm. In this way, when the retaining devices available for the movable arm are exhausted, it is possible to provide further retaining devices proximate the movable arm.

In certain embodiments, the charging seat comprises a replaceable charger, which is configured to contain the plurality of retaining devices stacked on top of each other and to be mounted on the rotating support element. In this way, when a charger runs out of the retaining devices contained therein, it is possible to replace the charger with an additional charger charged with retaining devices directly in the body of water, to continue the installation operations of the retaining devices on the pipeline without the need to bring the underwater vehicle back to the surface.

In certain embodiments, the charger extends about a central axis and comprises a plurality of housings arranged around the central axis, each of which extends along a respective axis substantially parallel to the central axis and is configured to contain a respective stack of retaining devices. In this way, after the movable arm has taken a retaining device from a stack of retaining devices, it is possible to rotate the charger about the central axis to provide a further retaining device of a further stack of retaining devices proximate the movable arm.

In certain embodiments, the frame of the underwater vehicle comprises a gantry structure provided with a first leg and a second leg; the first locomotion assembly being coupled to the first leg and the second locomotion assembly being coupled to the second leg such that, in use, the first and second locomotion assemblies are disposed from opposite bands of the pipeline with respect to the travel direction. In this way, it is possible to advance the underwater vehicle astride the pipeline.

In certain embodiments, the underwater vehicle comprises a cable positioning assembly configured to lay the cable on the pipeline. In certain such embodiments, the cable positioning assembly comprising a laying arm, which is provided with a first end coupled to the frame through a universal joint and a second end comprising a first guiding mechanism configured to guide the cable on the pipeline. In this way, it is possible to lay the cable on the pipeline in the so-called “piggyback” configuration and constrain the cable to the pipeline by the retaining devices.

In certain embodiments, the first guiding mechanism comprises a first roller assembly configured to slide on the pipeline, and a second roller assembly configured to determine a sliding of the cable with respect to the laying arm. In this way, it is possible to guide the cable on the pipeline following the development of the pipeline on the bed of the body of water.

In certain embodiments, the positioning assembly comprises at least one second actuator configured to control a support pressure exerted by the first guiding mechanism on the pipeline. In this way, it is possible to keep the second end of the laying arm in contact with the pipeline.

In certain embodiments, the positioning assembly comprises two second actuators, each of which is hinged to the frame at a first end and to the laying arm at a second end to control the pressure exerted by the laying arm on the pipeline.

In certain embodiments, the positioning assembly comprises a second guiding mechanism, which is coupled to the frame and comprises a third roller assembly configured to guide a slide of the cable with respect to the frame. In this way, it is possible to relatively precisely guide the cable towards the laying arm.

In certain embodiments, the second guiding mechanism is movable between a released position, wherein the cable is released from the second guiding mechanism, and a closed position, wherein the cable is tightened in the third roller assembly. In this way, it is possible to selectively retain/release the cable in/from the second guiding mechanism.

In certain embodiments, the underwater vehicle comprises an articulated service arm, which is configured to pick up the cable and to arrange the cable in the positioning assembly. In this way, it is possible to pick up the cable from the bed of the body of water and to arrange the cable in the first and in the second guiding mechanism.

Certain further aims of the present disclosure are to realize an installation method for installing retaining devices on an underwater pipeline that mitigates certain of the drawbacks of certain of the prior art.

In certain embodiments of the present disclosure, there is provided an installation method for installing retaining devices to retain a cable on an underwater pipeline laid on a bed of a body of water. In these embodiments, the method includes advancing an underwater vehicle on the bed of the body of water in a travel direction; accommodating a plurality of retaining devices, in certain instances stacked, in a charging seat of the underwater vehicle; taking a retaining device from the plurality of retaining devices; and applying the retaining device taken to the underwater pipeline.

In accordance with this method, it is possible to install the cable retaining devices on the pipeline directly on the bed of the body of water relatively avoiding slowing down the productivity of the pipe-laying ship and without the need to provide a station for the installation of the retaining devices on the pipe-laying ship. In this way, it is possible to relatively limit the installation costs and the risks connected with the installation of the retaining devices.

Certain further aims of the present disclosure are to realize an application method for applying a cable on an underwater pipeline which mitigates certain of the drawbacks of certain of the prior art.

In accordance with certain embodiments of the present disclosure, there is provided an application method for applying a cable to an underwater pipeline laid on a bed of a body of water. In these embodiments, the application method includes the steps of the installation method as described above as well as guiding the cable onto the pipeline by a laying arm of the underwater vehicle; and securing the cable to the pipeline by the retaining devices. In this way, it is possible to install the cable on the pipeline directly in the body of water relatively avoiding the risk of stretching or breaking the cable.

In accordance with certain embodiments, the installation method is carried out before guiding the cable onto the pipeline by the laying arm of the underwater vehicle and securing the cable to the pipeline by the retaining devices. In accordance with these embodiments, it is possible to install the retaining devices on the pipeline laid on the bed of a body of water using a first vessel used solely to support the underwater vehicle and, consequently, at a relatively low daily cost. In addition, it is possible to secure the cable to the retaining devices using a second vessel used solely to support the cable laying operations and, consequently, at a relatively low daily cost. In this way, it is possible to avoid the use of a relatively high daily cost pipe-laying ship configured to assemble the pipeline and install the cable on the pipeline before launching the pipeline.

In accordance with certain embodiments, the installation method is carried out simultaneously with the guiding the cable onto the pipeline by the laying arm of the underwater vehicle and securing the cable to the pipeline by the retaining devices. In accordance with these embodiments, it is possible to install the cable on the pipeline by a single support vessel or by two support vessels at a relatively low daily cost (i.e., by a first vessel for installing the retaining devices and a second vessel for applying the cable, avoiding imposing productivity limits on the pipe-laying ship at relatively high daily cost). In addition, in this way it is possible to install the cable on the pipeline without incurring relative inconveniences linked to the reduced stability of a cable laid on the bed of a body of water, subject to the actions of underwater currents and without retaining systems.

### BRIEF DESCRIPTION OF THE DRAWINGS

Further characteristics and advantages of the present disclosure will become clear from the following description of a non-limiting embodiment example thereof, with reference to the Figures of the attached drawings, wherein:

FIG. 1 is a schematic representation of a laying system for applying a cable to an underwater pipeline realized in accordance with the present disclosure;

FIG. 2 is a perspective view, with parts removed for clarity's sake, of an underwater vehicle of the laying system of FIG. 1;

FIGS. 3 and 4 are side elevational views, with parts removed for clarity's sake, of the underwater vehicle of FIG. 2 in respective operating configurations;

FIG. 5 is a plan view, with parts removed for clarity's sake, of the underwater vehicle of FIG. 2;

FIG. 6 is a perspective view, with parts removed for clarity's sake, of a detail of the underwater vehicle of FIG. 2;

FIG. 7 is a front view, with parts removed for clarity's sake, of the underwater vehicle of FIG. 2;

FIG. 8 is a bottom view, with parts removed for clarity's sake, of the underwater vehicle of FIG. 2;

FIG. 9 is a front view, with parts removed for clarity's sake, of a detail of the underwater vehicle of FIG. 2;

FIGS. 10 and 11 are perspective views, with parts removed for clarity's sake, of a detail of the underwater vehicle of FIG. 2 in respective operating configurations; and

FIG. 12 is a rear view, with parts removed for clarity's sake, of the underwater vehicle of FIG. 2.

### DETAILED DESCRIPTION

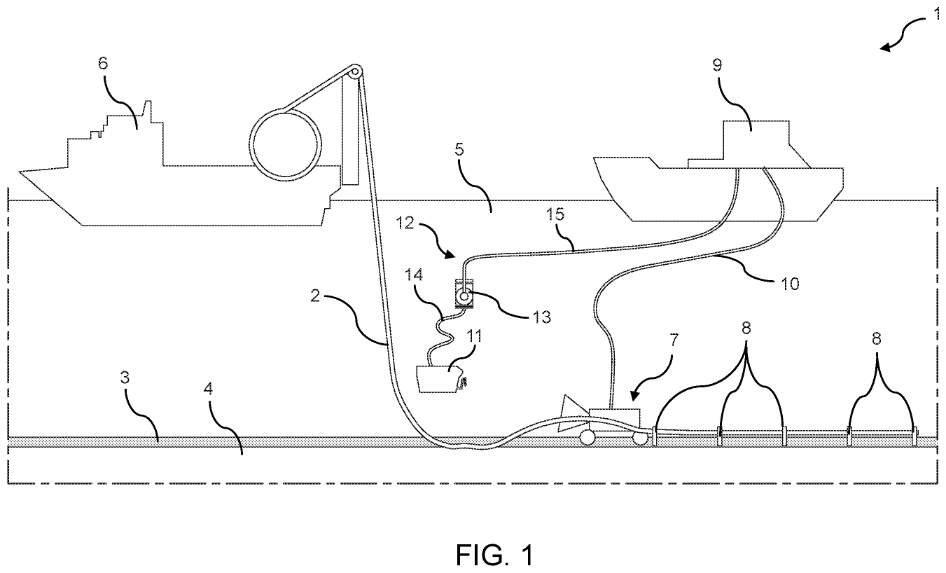

With reference to FIG. 1, number 1 denotes as a whole a laying system configured to apply a cable 2 to an underwater pipeline 3 laid on a bed 4 of a body of water 5, such as for example on a seabed.

In certain embodiments, the pipeline 3 is made of a metallic material and is configured to transport hydrocarbons. It is understood that the pipeline 3 can be used to transport further fluids without thereby departing from the scope of the present disclosure.

In accordance with certain non-limiting embodiments of the present disclosure, the cable 2 is an electrically conductive cable of a direct electric heating system of the pipeline 3, without thereby limiting the wide range of possible applications of the present disclosure.

In accordance with further embodiments, the cable 2 may be configured to transmit electrical power and/or signals.

The laying system 1 comprises a vessel 6, such as for example a cable-laying ship, configured to unwind and launch the cable 2 to arrange the cable 2 on the bed 4 of the body of water 5; an underwater vehicle 7, in certain instances tracked, configured to install retaining devices 8 to retain the cable 2 on the pipeline 3; a support vessel 9 configured to launch the underwater vehicle 7 and support the operations of the underwater vehicle 7; and an umbilical cable 10, which connects the underwater vehicle 7 to the support vessel 9 and is configured to feed electrical energy to the underwater vehicle 7 and to transmit/receive signals to/from the underwater vehicle 7.

In addition, the laying system 1 comprises an unmanned underwater vehicle 11, which is movable in the body of water 5 and is configured to support the installation operations of the cable 2 on the pipeline 3; and a connection assembly 12 for electrically connecting and for the exchange of signals the underwater vehicle 11 to the support vessel 9.

In the non-limiting case of the present disclosure described and shown herein, the underwater vehicle 11 is a Remote Operated Vehicle (“ROV”).

In certain embodiments, the connection assembly 12 comprises a cable management system 13, which is configured to be arranged in the body of water 5; a connection cable 14 for electrically connecting and for data exchange the underwater vehicle 11 to the cable management system 13; and an umbilical cable 15 for electrically connecting and for data exchange the cable management system 13 to the support vessel 9.

In the non-limiting case of the present disclosure described and shown herein, the underwater vehicle 7 is configured to guide the cable 2 on the pipeline 3 and to simultaneously install the retaining devices 8 on the pipeline 3 to secure the cable 2 to the pipeline 3.

In accordance with certain variants of the present disclosure (not shown in the Figures), the support vessel 9 is omitted from the laying system 1. In such a configuration, the vessel 6 is configured to launch the underwater vehicle 7 and support the operations of the underwater vehicle 7.

In accordance with an alternative embodiment (not shown in the Figures), the underwater vehicle 7 is configured to install the retaining devices 8 in a first step and the laying system 1 is configured to apply the cable 2 to the retaining devices 8 installed in a second step following the first step.

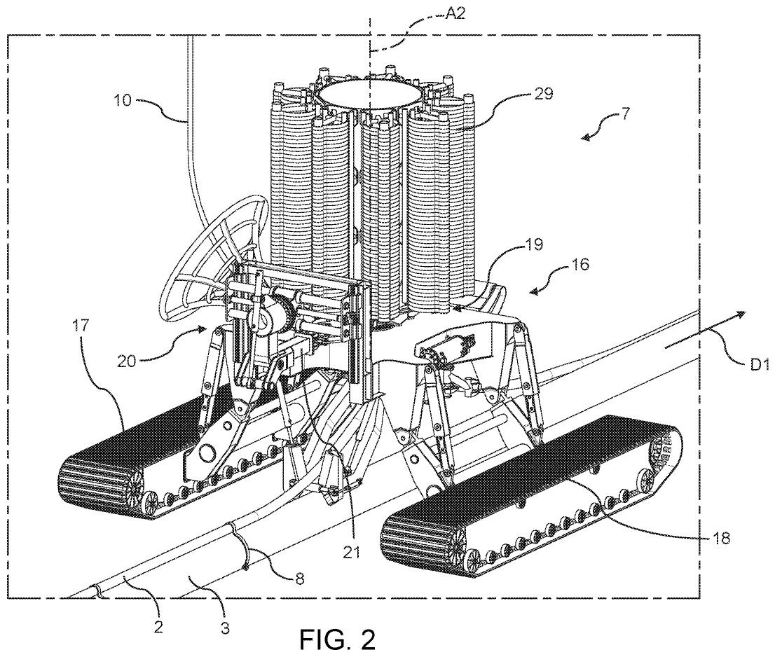

With reference to FIG. 2, the underwater vehicle 7 comprises a frame 16; a locomotion assembly 17 and a locomotion assembly 18, which are configured to advance the underwater vehicle 7 on the bed 4 of the body of water 5 in a travel direction D1; a charging seat 19 configured to accommodate a plurality of retaining devices 8 in certain instances stacked; and an installation mechanism 20 comprising a movable arm 21 configured to take a retaining device 8 from the plurality of retaining devices 8 and to apply the retaining device 8 taken on the underwater pipeline 3.

In the non-limiting case of the present disclosure described and shown herein, each locomotion assembly 17, 18 comprises a respective track.

In accordance with alternative embodiments (not shown in the Figures), each locomotion assembly 17, 18 may comprise a wheel or a set of wheels.

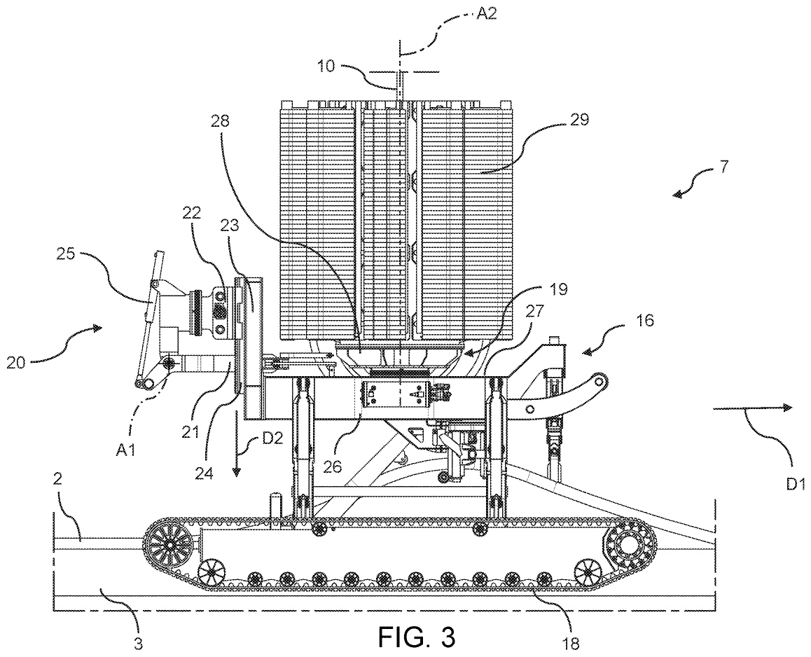

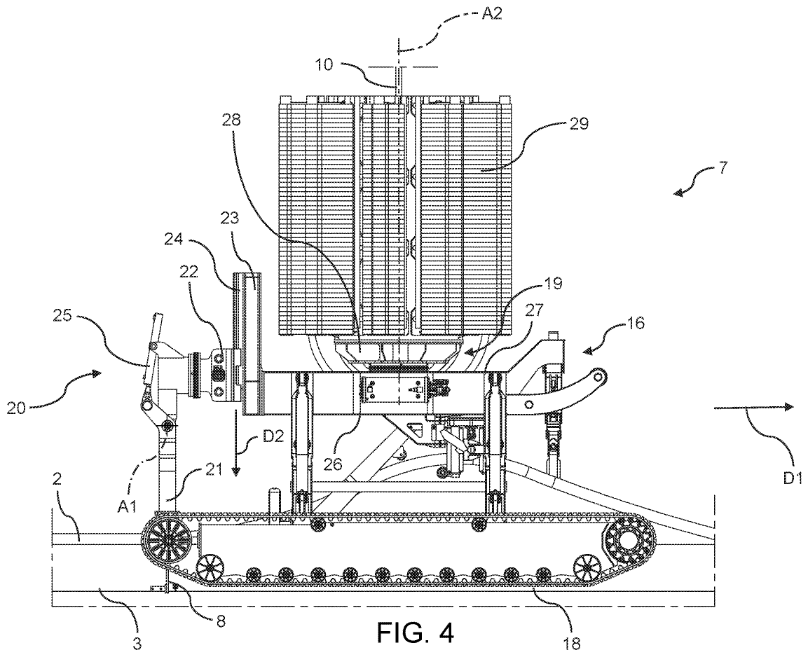

With reference to FIGS. 3 and 4, the installation mechanism 20 comprises a slider 22, which is sliding with respect to the frame 16 along a sliding direction D2 transverse to the travel direction D1 of the underwater vehicle 7. In particular, the sliding direction D2 is substantially perpendicular with respect to the travel direction D1.

In accordance with certain embodiments, the frame 16 comprises two uprights 23, and two guides 24, each of which is coupled to a respective upright 23 and extends along a direction substantially parallel to the sliding direction D2. The slider 22 is configured to slide along the guides 24.

The movable arm 21 is hinged to the slider 22 about a rotation axis Al to enable the rotation of the movable arm 21 with respect to the slider 22 between a taking position of the retaining device 8 and an application position of the retaining device 8. In particular, the installation mechanism 20 comprises a first actuator 25 configured to control the rotation of the movable arm 21 about the rotation axis A1. In greater detail, the actuator 25 is hinged to the slider 22 and to an end of the movable arm 21.

In the non-limiting case of the present disclosure described and shown herein, the frame 16 comprises a central body 26, which is provided with a substantially flat surface 27. The charging seat 19 is rotatably coupled to the frame 16 and, in particular, faces the surface 27. In particular, the charging seat 19 comprises a rotating support element 28 configured to rotatably support the plurality of retaining devices 8 to dispose the at least one retaining device 8 proximate the movable arm 21. In greater detail, the charging seat 19 comprises a replaceable charger 29, which is configured to contain the plurality of retaining devices 8 stacked on top of each other and to be mounted on the rotating support element 28.

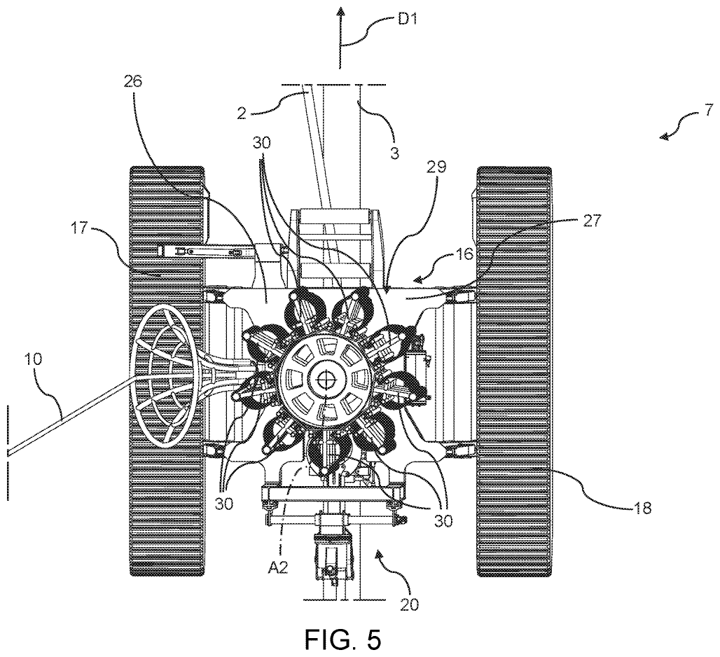

With reference to FIG. 5, the charger 29 extends about a central axis A2 and comprises a plurality of housings 30 arranged around the central axis A2, each of which extends along a respective axis substantially parallel to the central axis A2 and is configured to contain a respective stack of retaining devices 8. In particular, the housings 30 are angularly equally spaced around the central axis A2.

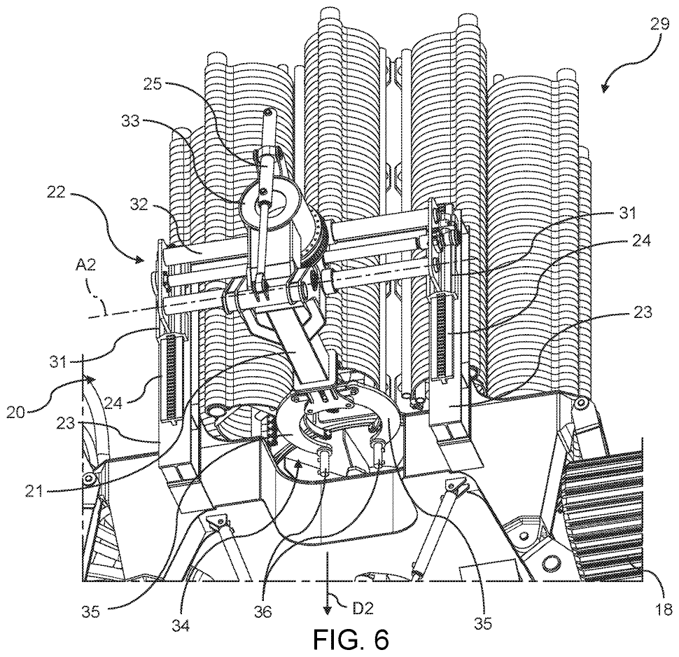

With reference to FIG. 6, the slider 22 comprises two sliding elements 31, each of which is configured to slide along the respective guide 24 in the sliding direction D2; a transverse support assembly 32, which extends transversely with respect to the guides 24 and is secured to the sliding elements 31; and a connection body 33, which is carried by the transverse support assembly 32 and comprises an end to which the movable arm 21 is hinged.

In accordance with certain embodiments, the movable arm 21 comprises a gripping member 34, such as for example a gripper, configured to selectively grasp or release the retaining device 8. In particular, the gripping member 34 is arranged at an end of the movable arm 21 opposite to the end of the movable arm 21 coupled to the actuator 25. In greater detail, the gripping member 34 comprises two movable gripping arms 35, each of which is provided with a sliding pin 36 configured to engage a respective opening formed in the retaining device 8.

From the operational point of view, the gripping arms 35 are movable between a closed position, wherein, in use, the gripping member 34 picks up the retaining device 8 from the stack of retaining devices 8, and an open position, wherein, in use, the gripping member 34 applies the retaining device 8 taken on the pipeline 3.

Each pin 36 is sliding between an extended position, wherein, in use, the pin 36 engages a respective opening formed in the retaining device 8, and a retracted position, wherein the pin 36 is released from the retaining device 8.

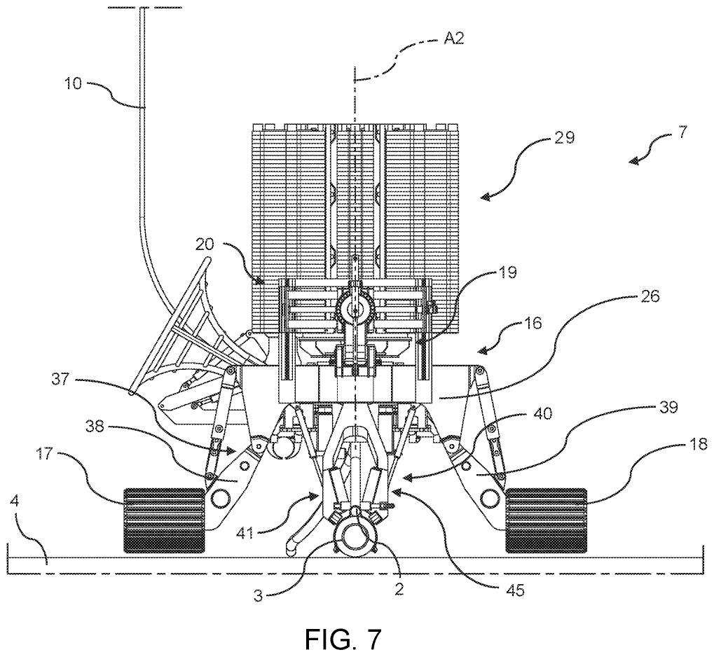

With reference to FIG. 7, the frame 16 comprises a gantry structure 37 provided with legs 38 and legs 39. The locomotion assembly 17 is coupled to the legs 38 and the locomotion assembly 18 is coupled to the legs 39 such that, in use, the locomotion assemblies 17 and 18 are disposed from opposite bands of the pipeline 3 with respect to the travel direction D1. In other words, the gantry structure 37 enables the underwater vehicle 7 to be arranged astride the pipeline 3.

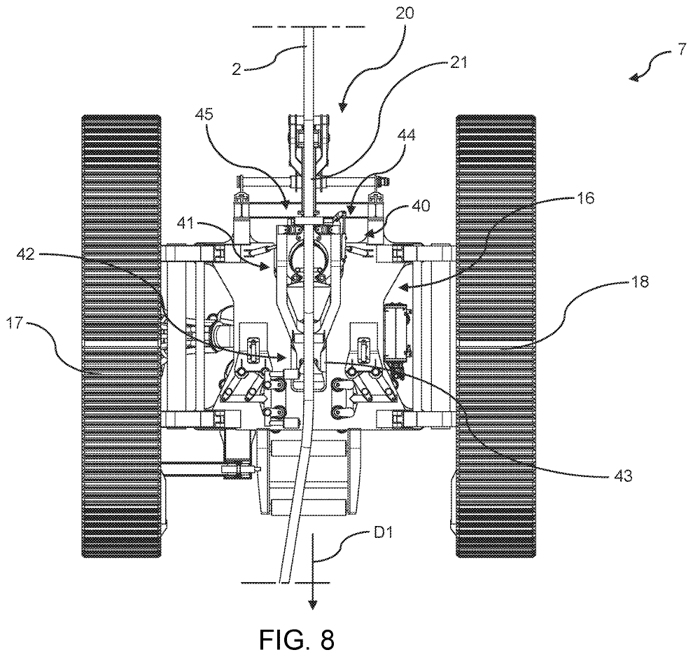

With reference to FIG. 8, the underwater vehicle 7 comprises a cable positioning assembly 40 configured to lay the cable 2 on the pipeline 3.

The positioning assembly 40 comprises a laying arm 41, which is provided with an end 42 coupled to the frame 16 through a universal joint 43 and with an end 44 comprising a guiding mechanism 45 configured to guide the cable 2 on the pipeline 3. In particular, the universal joint 43 allows or enables an oscillation of the laying arm 41 with respect to the frame 16.

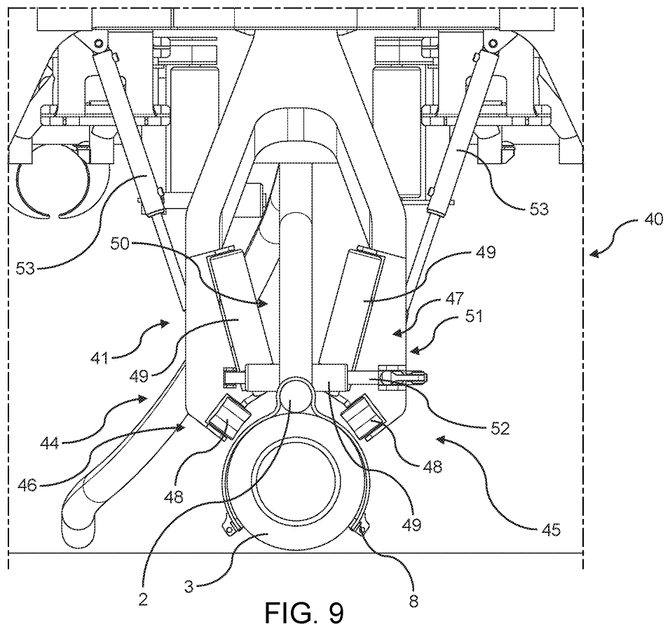

With reference to FIG. 9, the guiding mechanism 45 comprises a roller assembly 46 configured to slide on the pipeline 3, and a roller assembly 47 configured to determine a sliding of the cable 2 with respect to the laying arm 41.

In accordance with certain non-limiting embodiments of the present disclosure, the roller assembly 46 comprises two rollers 48, which are configured to be disposed from opposite bands of the pipeline 3 with respect to the travel direction D1 and to slide in contact with the pipeline 3. The roller assembly 47 comprises three rollers 49 coupled to the end 44 of the laying arm 41 to delimit a sliding seat 50 (FIG. 7) for the cable 2.

Furthermore, the guiding mechanism 45 comprises an adjustment system 51 configured to adjust the distance between the rollers 48 to adapt the roller assembly 46 to the dimensions of the pipeline 3. In particular, the adjustment system 51 comprises an actuator 52 configured to vary the distance between the rollers 48 to press the roller assembly 46 on the pipeline 3.

In the case described and shown herein, the positioning assembly 40 comprises at least one actuator 53 configured to control a support pressure exerted by the guiding mechanism 45 on the pipeline 3. In particular, the positioning assembly 40 comprises two actuators 53, each of which is hinged to the frame 16 at a first end and to the laying arm 41 at a second end.

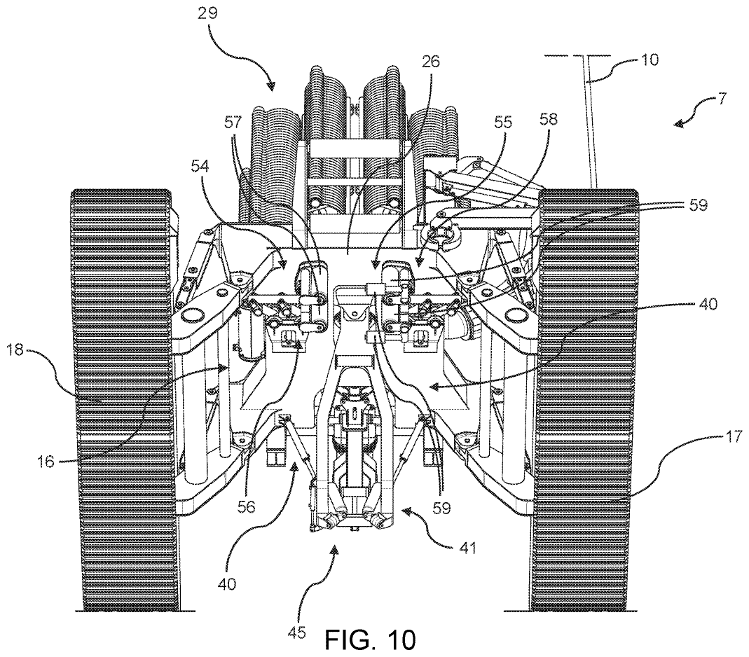

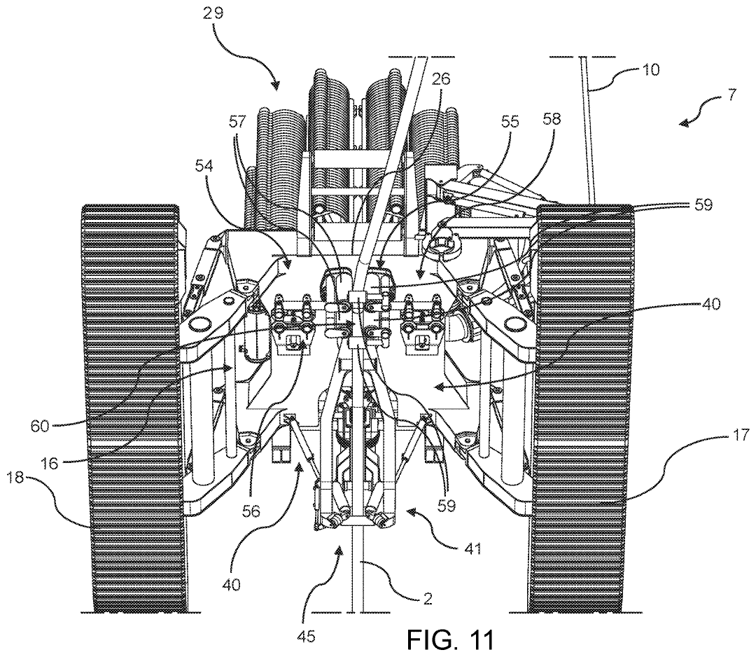

With reference to FIGS. 10 and 11, the positioning assembly 40 comprises a guiding mechanism 54, which is coupled to the frame 16, in particular to the central body 26, and comprises a roller assembly 55 configured to guide a slide of the cable 2 with respect to the frame 16. In particular, the guiding mechanism 54 is movable between a released position (FIG. 10), wherein the cable 2 is released from the guiding mechanism 54, and a closed position (FIG. 11), wherein the cable 2 is tightened in the roller assembly 55. In greater detail, the guiding mechanism 54 comprises a kinematic assembly 56 provided with rollers 57, and a kinematic assembly 58 provided with rollers 59. The kinematic assemblies 56 and 58 are configured to respectively move the rollers 57 and 59 between the released position and the closed position, wherein the rollers 57 and 59 delimit a sliding seat 60 for the cable 2.

In the non-limiting case of the present disclosure described and shown herein, the kinematic assemblies 56 and 58 comprise respective articulated quadrilateral kinematics.

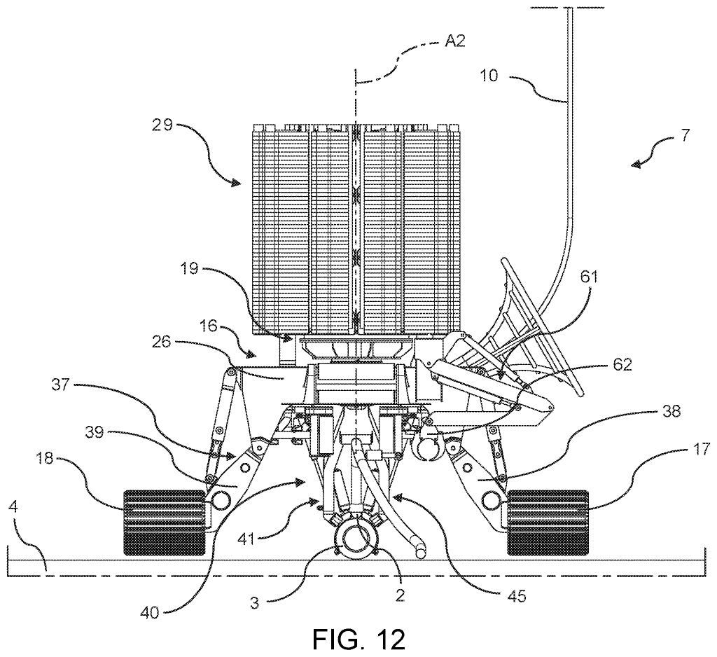

With reference to FIG. 12, the underwater vehicle 7 comprises an articulated service arm 61, which is configured to pick up the cable 2 and to arrange the cable 2 in the positioning assembly 40. In particular, the movable arm 61 comprises a gripping member 62 configured to selectively grasp or release the retaining device 2.

In use and with reference to FIG. 1, the vessel 6 unwinds the cable 2 to launch the cable 2 into the body of water 5. By advancing on the bed 4 of the body of water 5 along the pipeline 3, the underwater vehicle 7 guides the cable 2 on the pipeline 3 and applies the retaining devices 8 to the pipeline 3 to secure the cable 2 to the pipeline 3. The underwater vehicle 11 supports and monitors the installation operations of the cable 2 on the pipeline 3.

In certain embodiments, with reference to FIG. 12, the service arm 61 is operated such that the gripping member 62 grasps the cable 2 and arranges the cable 2 in the positioning assembly 40. In greater detail, the service arm 61 arranges the cable 2 in the guiding mechanism 54.

At this point, with reference to FIGS. 10 and 111, the kinematic assemblies 56 and 58 move the respective rollers 57 and 59 from the released position (FIG. 10) to the closed position (FIG. 11) to tighten the cable 2 in the sliding seat 60.

With reference to FIG. 9, the actuators 53 control the position of the guiding mechanism 45 to adjust the support pressure exerted by the guiding mechanism 45 on the pipeline 3.

At the same time, the actuator 52 of the adjustment system 51 adjusts the distance between the rollers 48 to adapt the roller assembly 46 to the dimensions of the pipeline 3.

In practice, during the advancement of the underwater vehicle 7, the roller assembly 46 remains in contact with the pipeline 3 to guide the positioning of the cable 2 on the pipeline 3 in the “piggyback” configuration following the development of the pipeline 3 on the bed 4 of the body of water 5.

During laying of the cable 2 on the pipeline 3, with reference to FIG. 6, the pins 36 of the gripping arms 35 slide from the retracted position to the extended position, to engage the respective openings formed in the retaining device 8. At this point, the gripping arms 35 move into the open position to release the retaining device 8 from the respective housing 30 of the charger 29.

With reference to FIGS. 3 and 4, once the retaining device 8 is coupled to the gripping member 34, the actuator 25 actuates the rotation of the movable arm 21 about the rotation axis Al from the taking position of the retaining device 8 (FIG. 3) to the application position of the retaining device 8 (FIG. 4).

Once the gripping arm 35 is in the application position, the slider 22 slides along the guides 24 in the sliding direction D2. In this way, the retaining device 8 coupled to the gripping member 34 is arranged around the cable 2 and the pipeline 3.

At this point, the gripping arms 35 of the gripping member 34 move from the open position to the closed position and the pins 36 move from the extended position to the retracted position to release the retaining device 8 on the pipeline 3.

Once the retaining device 8 is installed on the pipeline 3, the installation mechanism 20 brings the gripping arm 35 from the application position back to the taking position to pick up a further retaining device 8.

When the retaining devices 8 in a given housing 30 of the charger 29 are exhausted, the rotating support element 28 rotates around the central axis A2 to arrange a further housing 30 charged with retaining devices 8 proximate the gripping member 34.

In accordance with certain embodiments, the underwater vehicle 7 applies the retaining devices 8 to the pipeline 3 before the cable 2 is laid on the pipeline 3. In accordance with certain such embodiments, after the underwater vehicle 7 has installed the retaining devices 8 on the pipeline 3, the underwater vehicle 11 secures the cable 2 to the installed retaining devices 8.

In accordance with certain embodiments, the underwater vehicle 7 applies the retaining devices 8 to the pipeline 3 after the cable 2 has been laid on the pipeline 3. In accordance with the third embodiment, the laying of the cable 2 on the pipeline 3 can be carried out by the underwater vehicle 7 or by the underwater vehicle 11.

Finally, it is evident that variations can be made to the present disclosure with respect to the embodiments described without thereby departing from the scope of the following claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

The invention claimed is:

1-21. (canceled)

22: An underwater vehicle for installing retaining devices to retain a cable on an underwater pipeline laid on a bed of a body of water, the underwater vehicle comprising:
a frame;
a first locomotion assembly and a second locomotion assembly which are configured to advance the underwater vehicle on the bed of the body of water in a travel direction;
a charging seat configured to accommodate a plurality of retaining devices; and
an installation mechanism comprising a movable arm configured to take a retaining device from the plurality of retaining devices and apply the taken retaining device on the underwater pipeline.

23: The underwater vehicle of claim 22, wherein the movable arm comprises a gripping device configured to at least one of: selectively grasp the retaining device and selectively release the taken retaining device.

24: The underwater vehicle of claim 23, wherein the gripping device comprises two movable gripping arms, each of which is provided with a sliding pin configured to engage a respective opening defined by the retaining device.

25: The underwater vehicle of claim 22, wherein:
the installation mechanism comprises a slider configured to slide, with respect to the frame, along a sliding direction transverse to the travel direction of the underwater vehicle; and
the movable arm is hinged to the slider about a rotation axis to enable a rotation of the movable arm, with respect to the slider, between a taking position of the retaining device and an application position of the retaining device.

26: The underwater vehicle of claim 25, wherein the installation mechanism comprises an actuator configured to control the rotation of the movable arm about the rotation axis with respect to the slider.

27: The underwater vehicle of claim 22, wherein the charging seat comprises a rotating support element configured to rotatably support the plurality of retaining devices to dispose at least one of the retaining devices proximate the movable arm.

28: The underwater vehicle of claim 27, wherein the charging seat comprises a replaceable charger configured to contain the plurality of retaining devices stacked on top of each other and be mounted on the rotating support element.

29: The underwater vehicle of claim 28, wherein the replaceable charger extends about a central axis and comprises a plurality of housings arranged around the central axis, each of the housings extends along a respective axis substantially parallel to the central axis and is configured to contain a respective stack of retaining devices.

30: The underwater vehicle of claim 22, wherein the frame comprises a gantry structure comprising a first leg and a second leg, the first locomotion assembly being coupled to the first leg and the second locomotion assembly being coupled to the second leg such that, in use, the first locomotion assembly and the second locomotion assembly are disposed on opposite bands of the underwater pipeline with respect to the travel direction.

31: The underwater vehicle of claim 22, further comprising a cable positioning assembly configured to lay the cable on the underwater pipeline, wherein the cable positioning assembly comprises a laying arm with a first end coupled to the frame through a universal joint and a second end comprising a first guiding mechanism configured to guide the cable on the underwater pipeline.

32: The underwater vehicle of claim 31, wherein the first guiding mechanism comprises:
a first roller assembly configured to slide on the underwater pipeline, and
a second roller assembly configured to determine a sliding of the cable with respect to the laying arm.

33: The underwater vehicle of claim 31, wherein the cable positioning assembly comprises at least one first actuator configured to control a support pressure exerted by the first guiding mechanism on the underwater pipeline.

34: The underwater vehicle of claim 33, wherein the cable positioning assembly comprises two second actuators, each of which is hinged to the frame at a first end and to the laying arm at a second end.

35: The underwater vehicle of claim 31, wherein the cable positioning assembly comprises a second guiding mechanism coupled to the frame comprises a roller assembly configured to guide a slide of the cable with respect to the frame.

36: The underwater vehicle of claim 35, wherein the second guiding mechanism is movable between:
a released position in which the cable is released from the second guiding mechanism, and
a closed position in which the cable is tightened in the roller assembly.

37: The underwater vehicle of claim 31, further comprising an articulated service arm configured to pick up the cable and arrange the cable in the cable positioning assembly.

38: A method for installing retaining devices to retain a cable on an underwater pipeline laid on a bed of a body of water, the method comprising:
(i) advancing an underwater vehicle on the bed of the body of water in a travel direction;
(ii) accommodating a plurality of retaining devices in a charging seat of the underwater vehicle;
(iii) taking a retaining device from the plurality of retaining devices; and
(iv) applying the taken retaining device to the underwater pipeline.

39: A method for applying a cable to an underwater pipeline laid on a bed of a body of water, the method comprising:
(i) advancing an underwater vehicle on the bed of the body of water in a travel direction;
(ii) accommodating a plurality of retaining devices in a charging seat of the underwater vehicle;
(iii) taking a retaining device from the plurality of retaining devices;
(iv) applying the retaining device to the underwater pipeline;
(v) guiding the cable onto the underwater pipeline by a laying arm of the underwater vehicle; and
(vi) securing the cable to the underwater pipeline by the retaining device.

40: The method of claim 39, wherein (i) to (iv) occur before (v) and (vi).

41: The method of claim 39, wherein (i) to (iv) occur simultaneously with (v) and (vi).

42: The method of claim 41, further comprising:
laying a section of cable on the bed of the body of water alongside the underwater pipeline; and
retrieving the cable from the bed of the body of water by a service arm of the underwater vehicle.
